(19) United States
(12) Patent Application Publication
(10) Pub. No.: US 2026/0128542 A1
(43) Pub. Date: May 7, 2026

(54) CHARGING INLET

(71) Applicant: YAZAKI CORPORATION, Tokyo (JP)

(72) Inventors: Noriyoshi Yamanishi, Kakegawa-shi (JP); Shoya Ueda, Kakegawa-shi (JP)

(21) Appl. No.: 19/373,658

(22) Filed: Oct. 29, 2025

(30) Foreign Application Priority Data
Nov. 1, 2024 (JP) 2024-192756

(51) Int. Cl. H01R 13/00; B60L 53/16; H01R 13/502

(52) U.S. Cl. CPC H01R 13/005; B60L 53/16; H01R 13/502; H01R 2201/26

(57) ABSTRACT

A charging inlet includes a housing to and from which a charging plug is attachable and detachable and which holds a connection terminal inside, wherein the housing includes a fitting recess to and from which the charging plug is attached and detached, and a drain path extending from an inside of the fitting recess to an outside of the housing, wherein the drain path includes a drain passage extending in a horizontal direction in a state where a device to which the charging inlet is attached is on a horizontal plane, and wherein the drain passage has drain ports opened to the outside of the housing at both end portions in a length direction of the drain passage.

### BACKGROUND OF THE INVENTION

### Field of the Invention

Embodiments of the present invention relate to a charging inlet.

Priority is claimed on Japanese Patent Application No. 2024-192756 filed in Japan on November 1, 2024, the content of which is incorporated herein by reference.

### Description of the Related Art

In the related art, a connector installed in a vehicle has been proposed in order to supply (charge) electric power from the outside of the vehicle to a battery mounted on the vehicle such as an electric vehicle or a plug-in hybrid vehicle (see, for example, Patent Document 1). This type of connector is also generally referred to as a charging inlet. The charging inlet is provided with a drain path for draining water that has entered a housing.

### Prior Art Document

### Patent Document

Patent Document 1: Japanese Unexamined Patent Application, First Publication No. 2023-127174

### SUMMARY OF THE INVENTION

Meanwhile, in the charging inlet, a constitution for further improving a drain property of the housing is expected.

An embodiment provides a charging inlet with an improved drain property of a housing.

A charging inlet of an embodiment includes a housing to and from which a charging plug is attachable and detachable and which holds a connection terminal inside, wherein the housing includes a fitting recess to and from which the charging plug is attached and detached, and a drain path extending from an inside of the fitting recess to an outside of the housing, wherein the drain path includes a drain passage extending in a horizontal direction in a state where a device to which the charging inlet is attached is on a horizontal plane, and wherein the drain passage has drain ports opened to the outside of the housing at both end portions in a length direction of the drain passage.

According to an embodiment, it is possible to provide a charging inlet with an improved drain property of a housing.

### BRIEF DESCRIPTION OF THE DRAWINGS

FIG. 1 is a perspective view of a charging inlet according to an embodiment of the present invention.

FIG. 2 is a perspective view of the charging inlet as viewed in a different direction.

FIG. 3 is a cross-sectional view in an axial direction of a left and right center of the charging inlet.

FIG. 4 is a cross-sectional view in an axial direction of left and right side portions of the charging inlet.

FIG. 5 is a cross-sectional view taken along line A-A of FIG. 3.

FIG. 6 is a cross-sectional view corresponding to FIG. 3, illustrating the action of the embodiment.

FIG. 7 is a cross-sectional view corresponding to FIG. 5, illustrating the action of the embodiment.

FIG. 8A is a cross-sectional view corresponding to FIG. 5, illustrating an action when the charging inlet of the embodiment is inclined to one side of the left and right sides.

FIG. 8B is a cross-sectional view corresponding to FIG. 5, illustrating an action when the charging inlet of the embodiment is inclined to the other side of left and right sides.

FIG. 9 is a cross-sectional view corresponding to FIG. 5, illustrating another action of the charging inlet of the embodiment.

### DETAILED DESCRIPTION OF THE INVENTION

Specific embodiments of the present invention will be described below with reference to the drawings. In the following description, constitutions having the same or similar functions are denoted by the same reference numbers. Redundant descriptions of these constitutions may be omitted. The constitution which will be described below does not limit the scope of the embodiment.

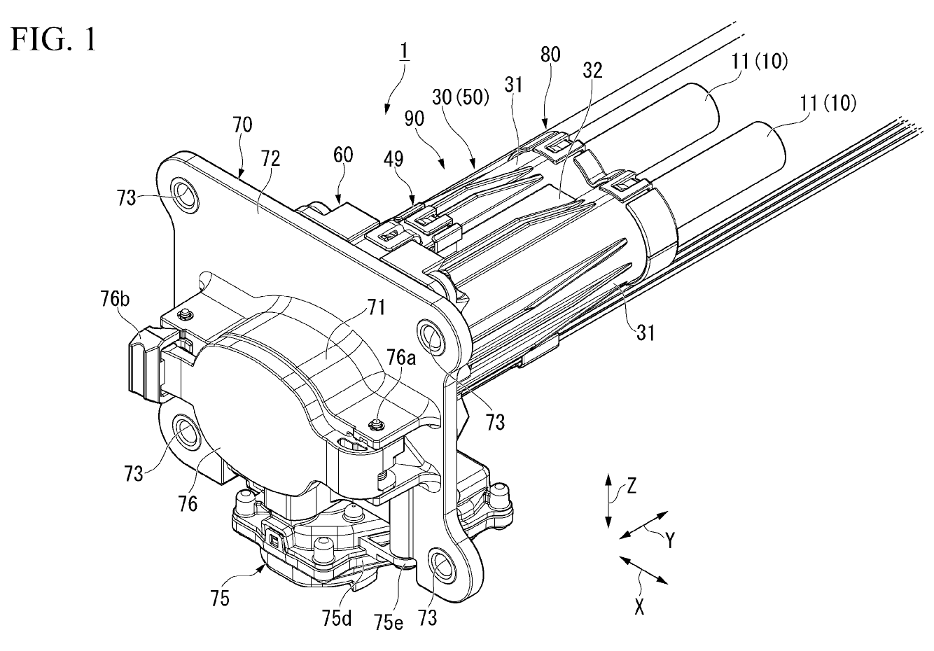

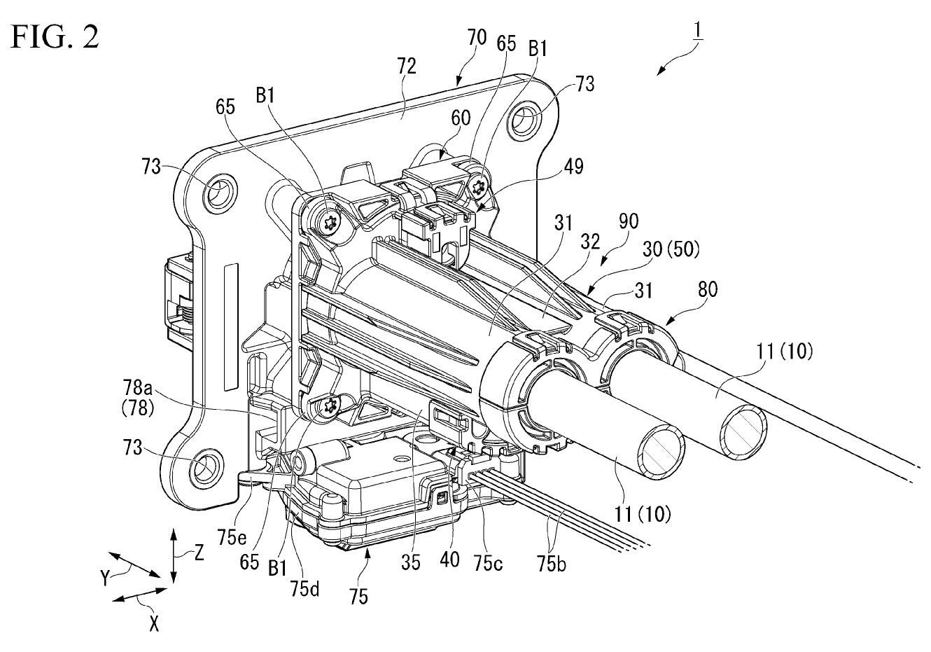

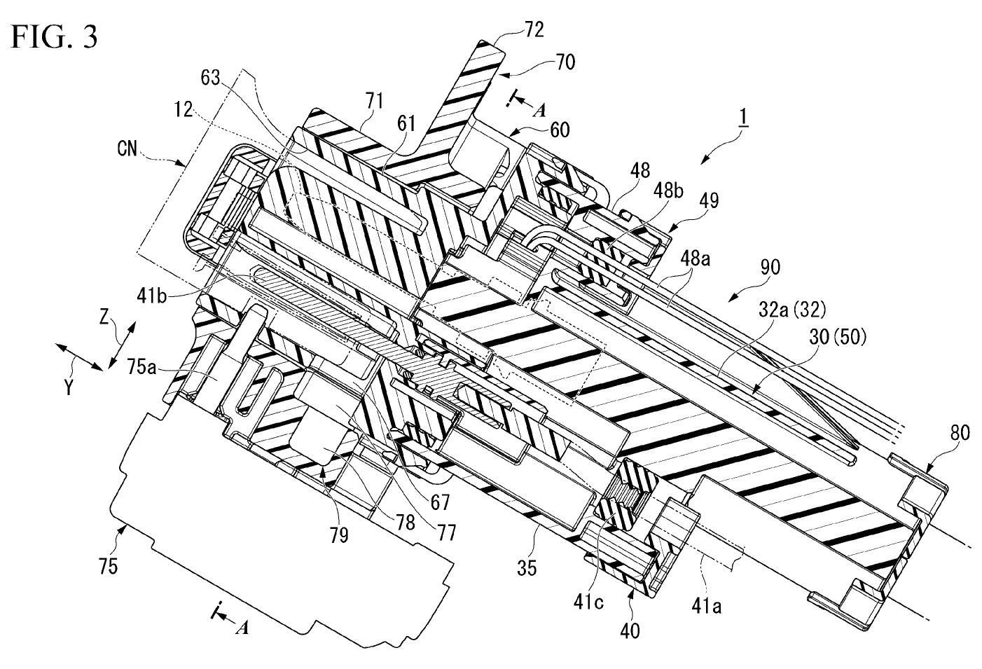

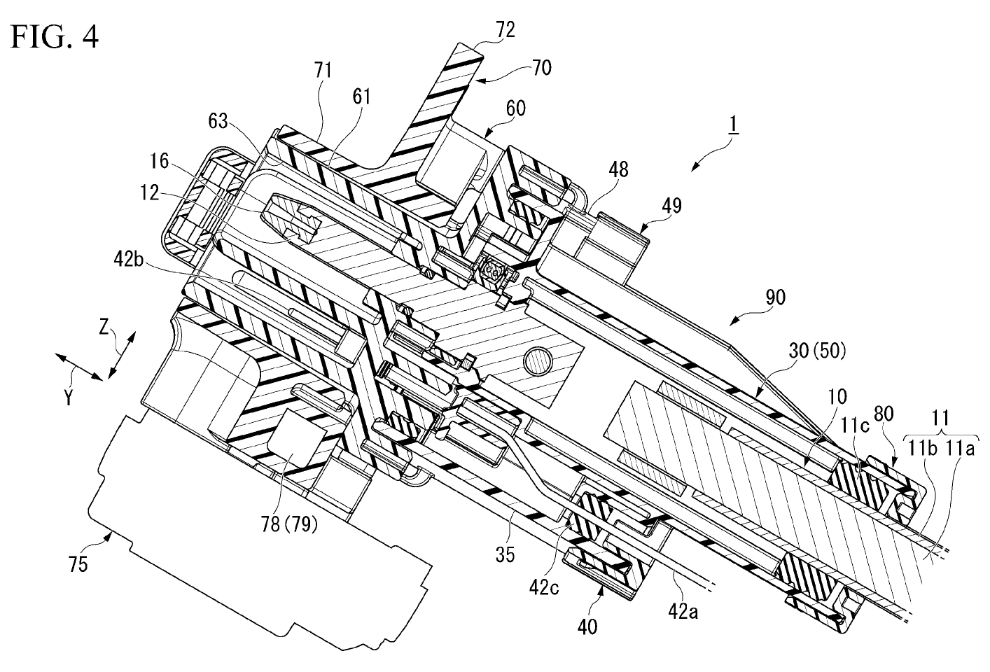

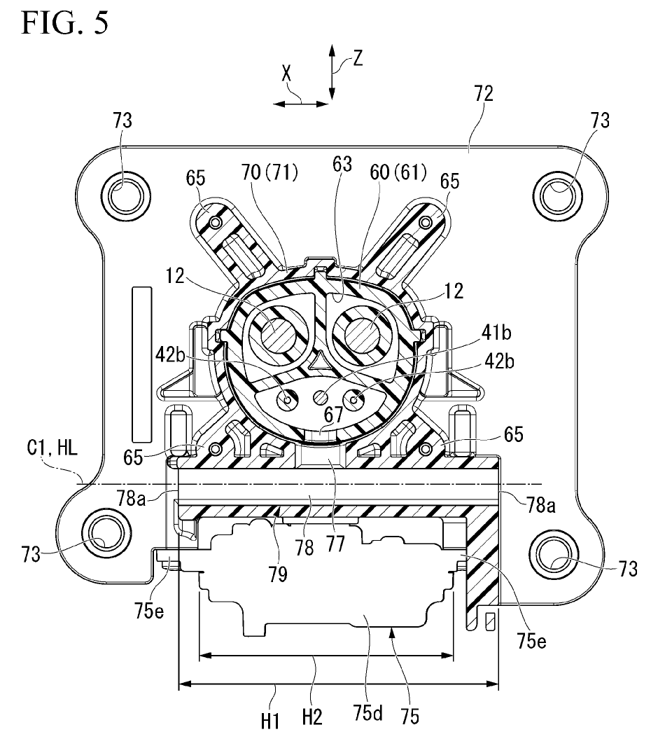

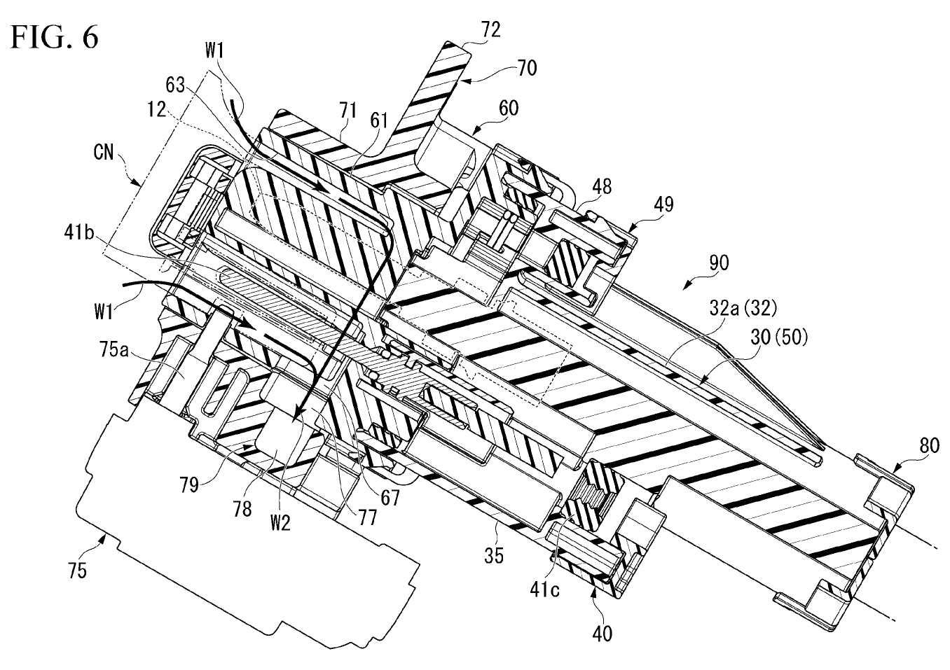

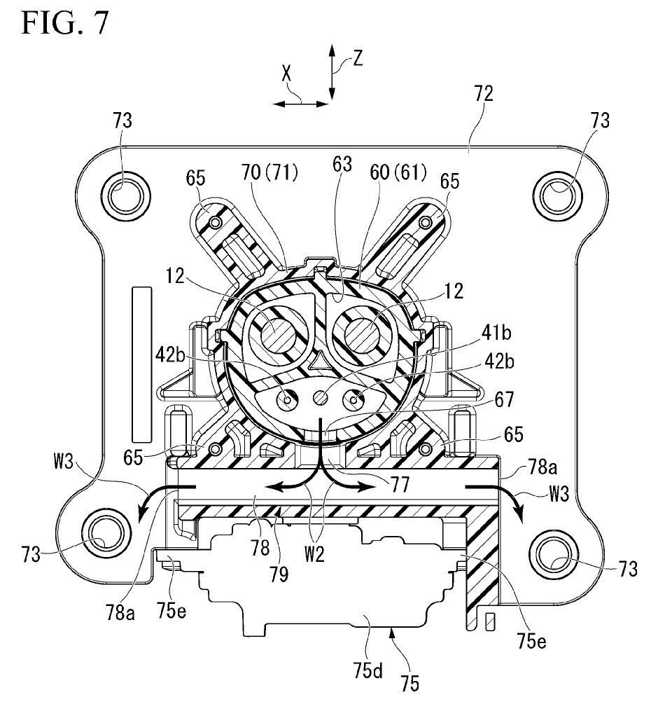

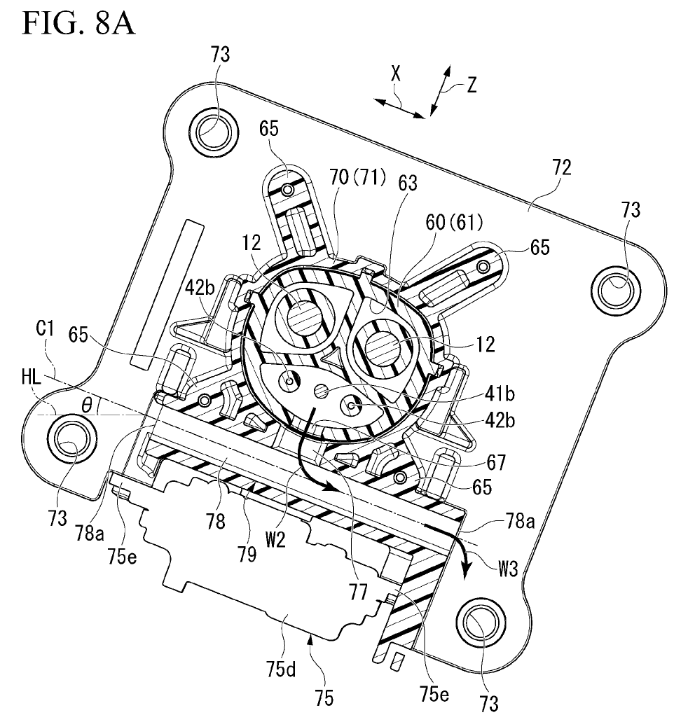

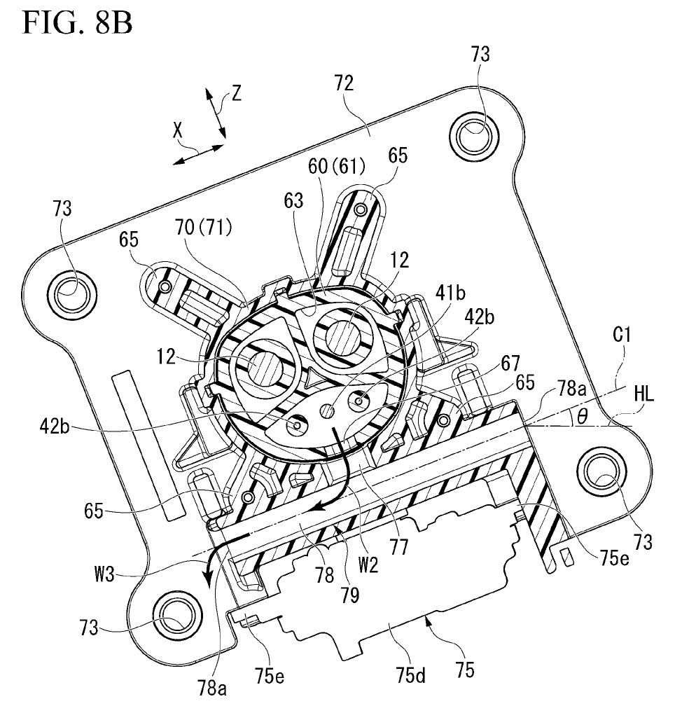

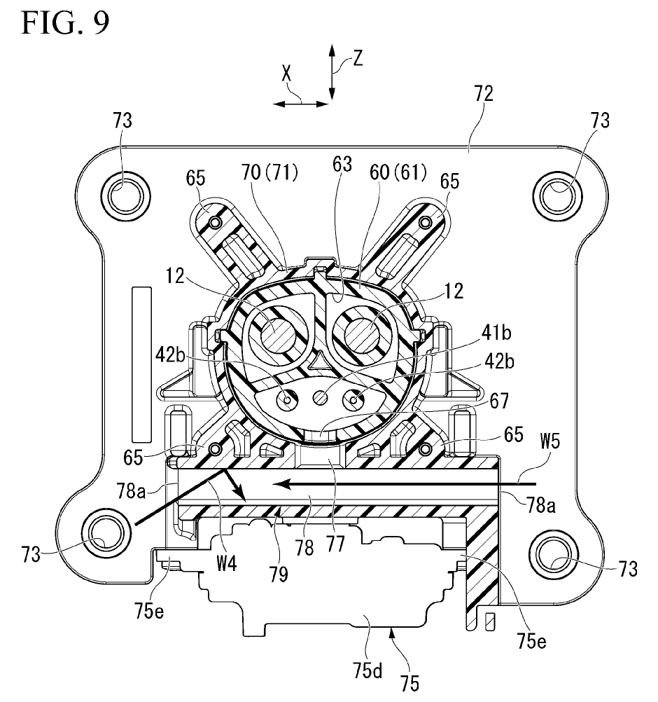

FIGS. 1 and 2 are a perspective views of a charging inlet 1 according to an embodiment of the present invention. FIG. 3 is a cross-sectional view in an axial direction of a left and right center of the charging inlet 1. FIG. 4 is a cross-sectional view in an axial direction of left and right side portions of the charging inlet 1. FIG. 5 is a cross-sectional view taken along line A-A of FIG. 3. FIG. 6 is a cross-sectional view corresponding to FIG. 3, illustrating the action of the embodiment. FIG. 7 is a cross-sectional view corresponding to FIG. 5, illustrating the action of the embodiment. FIG. 8A is a cross-sectional view corresponding to FIG. 5, illustrating an action when the charging inlet 1 is inclined to one side of the left and right sides. FIG. 8B is a cross-sectional view corresponding to FIG. 5, illustrating an action when the charging inlet 1 is inclined to the other side of left and right sides. FIG. 9 is a cross-sectional view corresponding to FIG. 5, illustrating another action of the charging inlet 1. In the present specification, the description will be given on the assumption that an arrow X indicates a left-right direction, an arrow Y indicates a front-rear direction, and an arrow Z indicates an up-down direction.

The charging inlet 1 illustrated in FIGS. 1 and 2 is a connector that is installed in a vehicle equipped with a battery such as an electric vehicle (EV) or a plug-in hybrid electric vehicle (PHEV) and is connected to an electric wire 10 extending from the battery mounted in the vehicle. A mating connector CN such as a charging plug (not illustrated) is detachably fitted in a fitting recess 63 (see FIG. 1 and the like) of the charging inlet 1. The mating connector CN is connected to an electric wire extending from a power feeding device outside the vehicle. By connecting the mating connector CN to the charging inlet 1, electric power is supplied to the battery from the power feeding device outside the vehicle, and the battery is charged.

In the embodiment, a fitting direction (insertion/removal direction) of the charging inlet 1 and the mating connector CN will be described as the front-rear direction. In the front-rear direction, a side of the mating connector CN is referred to as a front side, and a side of the charging inlet 1 is referred to as a rear side. That is, the mating connector CN is fitted and connected to the charging inlet 1 through movement from the front side to the rear side and is removed through movement in the opposite direction. The fitting direction may be inclined forward and upward with respect to a horizontal direction. Left and right sides in the left-right direction are left and right sides when facing forward.

As illustrated in FIGS. 1 and 2, the charging inlet 1 includes a pair of terminal-equipped electric wires 10 and a housing 90 in which terminals 12 of the pair of terminal-equipped electric wires 10 are housed and the pair of terminal-equipped electric wires 10 are held.

Referring also to FIG. 4, the pair of terminal-equipped electric wires 10 connect one-side end portions of a pair of electric wires 11 to the pair of terminals 12. The other-side end portions of the pair of electric wires 11 are connected to a battery (not illustrated). The electric wire 11 includes a conductor core wire 11a and a sheath 11b made of an insulating resin that covers the conductor core wire 11a. The electric wire 11 is held in the housing 90 via a rubber stopper 11c.

The pair of terminals 12 has the same constitution. Each terminal 12 extends linearly in the front-rear direction. The terminals 12 are arranged side by side in the left-right direction with an interval. The terminals 12 are inserted into and held in a pair of terminal holding portions 31 which will be described later.

For example, each terminal 12 is provided with a cylindrical female terminal portion 16 (see FIG. 4) protruding forward from a front end surface thereof. Among the pair of terminals 12, the female terminal portion 16 of one terminal 12 functions as a positive electrode-side terminal, and the female terminal portion 16 of the other terminal 12 functions as a negative electrode-side terminal. When the charging inlet 1 is fitted to the mating connector CN, a male terminal portion on a positive electrode side and a male terminal portion on a negative electrode side (both not illustrated) of the mating connector CN are connected to the female terminal portion 16 of one terminal 12 and the female terminal portion 16 of the other terminal 12, respectively.

Rear end portions of the pair of terminals 12 are connected to one-side end portions of the electric wires 11. The conductor core wire 11a exposed at one-side end portion of the electric wire 11 is connected to a rear end portion of the terminal 12 directly or via a prescribed conductor component. With this constitution, the terminal 12 and one-side end portion of the electric wire 11 are electrically connected.

### Housing 90

As illustrated in FIGS. 1 and 2, the housing 90 includes a base holder 50, a rear holder 80, an inner housing body 60, and an outer housing body 70. Each of the base holder 50, the rear holder 80, the inner housing body 60, and the outer housing body 70 is a skeletal component of the housing 90 and forms an outer surface of the housing 90.

The base holder 50 functions to hold the pair of terminal-equipped electric wires 10 in a state of being insulated from each other with an interval in width direction. The base holder 50 includes a resin holder 30 which is a resin molded article.

The resin holder 30 functions to absorb and radiate heat generated in the pair of terminals 12 and to insulate and protect the pair of terminals 12. The resin holder 30 integrally includes a pair of terminal holding portions (holder bodies) 31 arranged in the width direction (left-right direction) and a coupling portion 32 that couples the pair of terminal holding portions 31 in the width direction. Each terminal holding portion 31 has a substantially cylindrical shape extending in the front-rear direction. The terminal 12 is inserted into each of the pair of terminal holding portions 31 from the rear.

The coupling portion 32 couples the pair of terminal holding portions 31. An upper wiring guide 48 protruding upward is provided on an upper side outer surface (upper surface) 32a of the coupling portion 32, and a lower wiring guide 35 protruding downward is provided on a lower side outer surface (lower surface; not illustrated) of the coupling portion 32.

Referring to FIGS. 3 and 4 together, the upper wiring guide 48 has a function of guiding the routing of an electric wire of an electric wire component (for example, a thermistor 48a for temperature detection of the terminal 12, or the like) different from the electric wire 10 for charging. A cap member 49 is attached to the upper wiring guide 48. In the drawing, reference numeral 48b denotes a rubber stopper that holds the electric wire in the upper wiring guide 48.

The lower wiring guide 35 has a function of guiding the routing of an electric wire of an electric wire component (for example, a ground electric wire 41a, various signal electric wires 42a, and the like) different from the electric wire 10 for charging. A cap member 40 is attached to the lower wiring guide 35. In the drawing, reference numerals 41c and 42c denote rubber stoppers that hold the electric wires in the lower wiring guide 35.

The rear holder 80 is attached to a rear end portion of the base holder 50. The rear holder 80 is a resin molded article, is assembled to the base holder 50 from the rear, and functions to hold the pair of terminal-equipped electric wires 10 in a state of being spaced apart in the width direction.

In front of the base holder 50, an inner housing body 60 having a size that surrounds the outside of the pair of terminal holding portions 31 when viewed in the front-rear direction is provided. The inner housing body 60 has a disk shape with a thickness direction oriented in the front-rear direction, and a front end portion of the base holder 50 is coupled to a rear surface portion of the inner housing body 60. The inner housing body 60 is, for example, a resin molded article integrally formed of the same material as the base holder 50.

The inner housing body 60 integrally includes a cylindrical portion 61 having a cylindrical shape and extending in the front-rear direction, and a rear wall portion (not illustrated) closing a rear opening of the cylindrical portion 61. The cylindrical portion 61 and the rear wall portion form the fitting recess 63 that is opened forward and is recessed rearward.

In the fitting recess 63, the female terminal portions 16 of the pair of terminals 12 are provided so as to protrude forward from the rear wall portion of the cylindrical portion 61.

A bolt insertion portion 65 for fastening and fixing the inner housing body 60 to the outer housing body 70 with a bolt B1 in the front-rear direction is formed on an outer peripheral side (both left and right sides of an upper portion and both left and right sides of a lower portion) of a rear end portion of the cylindrical portion 61.

In a rear wall portion (bottom wall portion) of the fitting recess portion 63, a pair of cylindrical female terminal housing portions (not illustrated) are provided so as to protrude forward corresponding to the female terminal portions 16 of the pair of terminals 12. Each female terminal housing portion is located in the fitting recess 63 and houses the female terminal portion 16 therein.

The outer housing body 70 is assembled to the inner housing body 60 from the front and functions to fix the entire housing 90 to an attachment target portion (not illustrated) provided in the vehicle. The outer housing body 70 is a resin molded article and has a cylindrical portion 71 extending in the front-rear direction. The cylindrical portion 71 is provided such that the cylindrical portion 61 of the inner housing body 60 is inserted thereinto and the cylindrical portion 71 covers an outer peripheral surface of the cylindrical portion.

A flange portion 72 expanding radially outward is provided on an outer peripheral side of a front-rear intermediate portion of the cylindrical portion 71. The flange portion 72 has a rectangular shape when viewed in the front-rear direction. A bolt insertion hole 73 passing through the flange portion 72 in the front-rear direction is formed at each corner of the flange portion 72. A bolt (not shown) for fixing the charging inlet 1 to the attachment target portion of the vehicle is inserted into the bolt insertion hole 73.

The charging inlet 1 includes an actuator 75 for preventing detachment of the mating connector CN in a connected state. The actuator 75 is attached to a lower end portion of the outer housing body 70 from below. The actuator 75 includes a lock pin 75a that can be inserted into a prescribed portion of the mating connector CN in a connected state in a direction (for example, an up-down direction) orthogonal to the fitting direction. The actuator 75 is actuated with a drive signal from a control device (not illustrated) and causes the lock pin 75a to protrude and retract with respect to the mating connector CN. With this constitution, it is possible to prevent the mating connector CN from being accidentally detached or intentionally detached during battery charging, improve safety, and reliably perform a charging cycle every time. The actuator 75 is an independent unit and is fixed to the housing 90 with a bolt, a nut, and the like.

With reference also to FIG. 5, a connector 75c for connecting an electric wire 75b for power supply and control is attached to a rear end portion of the actuator 75. In the drawing, reference numeral 75d denotes a case that houses electric components in the actuator 75, and reference numeral 75e denotes a fastening flange for fixing the case 75d to the outer housing body 70. The electric wire 75b and the connector 75c are connected to an upper surface portion of the case 75d.

A lid 76 for opening and closing a front opening of the cylindrical portion 71 is attached to a front surface side of the outer housing body 70. The lid 76 is disposed on one side of the left and right sides (left side in the drawing) of the cylindrical portion 71 and is rotatable about a hinge shaft 76a extending in the up-down direction. On the other side of left and right sides (right side in the drawing) of the cylindrical portion 71, a lock member 76b that holds the lid 76 in a closed state is disposed.

### Drain Path 79 of Housing 90

Referring to FIGS. 6 and 7, the charging inlet 1 is disposed with the fitting direction (front-rear direction) inclined forward and upward in an attached state to the vehicle. Specifically, in a state where the vehicle (device) that is an attachment target of the charging inlet 1 is to be attached is on a horizontal plane (hereinafter, it is referred to as a “device horizontal state”), the fitting direction (front-rear direction) is inclined frontward and upward with respect to the horizontal direction.

When the fitting direction is inclined forward and upward, a front opening of the fitting recess 63 to which the mating connector CN is fitted faces upward. With this constitution, when water is splashed on the charging inlet 1 in a state where the lid 76 is opened and the mating connector CN is fitted in the fitting recess 63, water may enter a gap between the mating connector CN and the fitting recess 63 (see arrow W1 in the drawing). In order to prevent this water from accumulating in the fitting recess 63, the inner housing body 60 has a drain hole 67 passing through a bottom portion of the fitting recess 63 downward at a lower end position (a rear lower end position of the cylindrical portion 61).

The power supply terminal 12, a ground terminal 41b, a signal terminal 42b, and the like facing the fitting recess portion 63 are held by the inner housing body 60 via a seal member such as an O-ring at a base on a side of the inner housing body 60. With this constitution, water is prevented from entering the housing 90 from the holding portion of each terminal.

A lower portion of the outer housing body 70 includes a second drain hole 77 connected below the drain hole 67 of the inner housing body 60, and a drain passage 78 communicating with the second drain hole 77. The drain passage 78 extends linearly in the left-right direction. A line C1 in the drawing indicates an axis in an extending direction of the drain passage 78, and a line HL indicates a horizontal direction. In the embodiment, the axis of the drain passage 78 is in the left-right direction. Both left and right end portions of the drain passage 78 are drain ports 78a opened outward in the left-right direction. The drain holes 67 and 77 and the drain passage 78 form a drain path 79 extending from the inside of the fitting recess 63 to the outside of a lower portion of the housing 90.

In the device horizontal state, the axis of the drain passage 78 is in the horizontal direction. The second drain hole 77 is opened in an intermediate portion (for example, a central portion) of the drain passage 78 in the left-right direction. When water enters the fitting recess 63 (see arrow W1 in the drawing), the water reaches the left and right intermediate portion of the drain passage 78 through the drain hole 67 and the second drain hole 77 (see arrow W2 in the drawing), appropriately flows to both left and right sides of the drain passage 78, and is discharged to the outside of the housing 90 from the left and right drain ports 78a (see arrow W3 in the drawing).

A left and right width H1 between the left and right drain ports 78a is wider than a left and right width H2 of the case 75d that houses at least electric components of the actuator 75 fixed to a lower end portion of the housing 90. Therefore, the water discharged from the left and right drain ports 78a is discharged to the outside of the housing 90 without coming into contact with an upper surface of the case 75d. By connecting the drain holes 67 and 77 extending in the up-down direction to the intermediate portion of the drain passage 78 extending in the left-right direction, a bent flow path is formed by the drain passage 78 and the drain holes 67 and 77 up to the fitting recess 63 as viewed from any of the left and right drain ports 78a.

FIG. 7 illustrates a case where the vehicle equipped with the charging inlet 1 is on a horizontal plane. In this case, the drain passage 78 is horizontally disposed in a vehicle left-right direction. With this constitution, water that has reached the drain passage 78 is appropriately drained from the left and right drain ports 78a.

FIGS. 8A and 8B illustrate a state in which the vehicle equipped with the charging inlet 1 is inclined to one side or the other side in the left-right direction. In this case, the drain passage 78 is disposed to be inclined by an angle θ with respect to a horizontal line HL in the vehicle left-right direction. Also in this case, since the drain passage 78 has the drain ports 78a on both left and right sides of the housing 90, it is possible to reliably drain water without storing water that has reached the drain passage 78.

In addition, as shown in FIG. 9, even if upward water is blown to the drain port 78a (see arrow W4 in FIG. 9), since this water collides with a wall surface of the drain passage 78 having a length and drops, the water is not directly blown to the drain holes 67 and 77. In addition, even if water is blown to the drain port 78a in the left-right direction (see arrow W5 in the drawing), this water flows through the drain passage 78 and is discharged from the other drain port 78a, and thus the water is not directly blown to the drain holes 67 and 77.

### Action and Effect

As described above, a charging inlet 1 according to the present embodiment includes a housing 90 to and from which a charging plug is attachable and detachable and which holds a connection terminal 12 inside, wherein the housing 90 includes a fitting recess 63 to and from which the charging plug is attached and detached, and a drain path 79 extending from an inside of the fitting recess 63 to an outside of a lower portion of the housing 90, wherein the drain path 79 includes a drain passage 78 extending in a horizontal direction in a state where a device to which the charging inlet 1 is attached is on a horizontal plane, and wherein the drain passage 78 has drain ports 78a opened to the outside of the housing 90 at both end portions in a length direction of the drain passage 78.

According to this constitution, by providing the drain path 79 opened from the inside of the fitting recess 63 to the outside of the housing 90, water that has entered the fitting recess 63 can be discharged to the outside of the housing 90. Since the drain path 79 has the drain ports 78a at both end portions in the length direction of the drain passage 78 extending in the horizontal direction, it is possible to drain water from at least one of the two drain ports 78a even in a state where the device to which the charging inlet 1 is attached is inclined.

In the charging inlet 1 of the embodiment, the drain passage 78 extends in a direction (vehicle left-right direction X) intersecting a fitting direction (vehicle front-rear direction Y) of the charging inlet 1 and the mating connector CN when viewed in the fitting direction thereof.

According to this constitution, since the drain passage 78 extends horizontally in the direction intersecting the fitting direction of the charging inlet 1, it is possible to appropriately drain water from the drain ports 78a at both end portions in the width direction intersecting the fitting direction. In particular, if the width direction of the charging inlet 1 is oriented in the width direction of the device that is an attachment target, even when the device is inclined in the width direction, water can be reliably discharged from one of the two drain ports 78a.

The charging inlet 1 the embodiment further includes an electric device (actuator 75) attached to a lower portion of the housing 90, wherein both drain ports 78a of the drain passage 78 are located outside the actuator 75 in the length direction in a state where the device to which the charging inlet 1 is attached is on a horizontal plane.

According to this constitution, since the drain port 78a is opened outside the actuator 75 below the housing 90, it is possible to suppress the drainage from the drain port 78a from contacting the actuator 75 and to simplify a waterproof structure of the actuator 75.

In the charging inlet 1 of the embodiment, the drain path 79 includes drain holes 67 and 77 extending downward from the fitting recess 63, and the drain holes 67 and 77 are connected to an intermediate portion of the drain passage 78 in the length direction.

According to this constitution, since the drain holes 67 and 77 extending downward from the fitting recess 63 are connected to the intermediate portion of the drain passage 78 in the length direction, the fitting recess 63 and the drain passage 78 can be easily connected via the drain holes 67 and 77, and drainage can be satisfactorily guided from the intermediate portion of the drain passage 78 in the length direction to both drain ports 78a.

In the charging inlet 1 of the embodiment, the housing 90 includes an inner housing (inner housing body 60) that faces an inner side of the fitting recess 63, and an outer housing (outer housing body 70) that covers an outer side of the inner housing body 60, and the drain path 79 is formed across the inner housing body 60 and the outer housing body 70.

According to this constitution, since the drain path 79 is formed across the inner housing body 60 and the outer housing body 70, the drain path 79 can be easily formed, for example, by forming the drain path 79 from an engaging portion between the inner housing body 60 and the outer housing body 70 as compared with a case where the drain path 79 is formed in one of the inner housing body 60 and the outer housing body 70.

In the above embodiment, the constitution in which the charging inlet 1 is mounted on the vehicle, the fitting direction of the charging inlet 1 is oriented in the vehicle front-rear direction, and the length direction of the drain passage 78 is oriented in the vehicle left-right direction has been exemplified. In this case, when the vehicle is inclined so as to lower downward one side in the vehicle width direction (vehicle left-right direction), as illustrated in FIGS. 8A and 8B, the drain port 78a on one side in the length direction intersecting (orthogonal to) the fitting direction in the drain passage 78 is lowered downward, and drainage can be performed from the drain port 78a. For example, a constitution in which the fitting direction of the charging inlet 1 is oriented in the vehicle left-right direction and the length direction of the drain passage 78 is oriented in the vehicle front-rear direction may be adopted. In this case, when the vehicle is inclined so as to lower downward one side in the vehicle front-rear direction, the drain port 78a on one side in the length direction intersecting (orthogonal to) the fitting direction in the drain passage 78 is lowered downward, and drainage can be performed from the drain port 78a.

The constitution in the above embodiment is an example of the present invention, and various modifications can be made without departing from the gist of the present invention, such as replacing the components of the embodiment with known components.

### REFERENCE SIGNS LIST

1 Charging inlet

12 Connection terminal

60 Inner housing body (inner housing)

63 Fitting recess

67 Drain hole

70 Outer housing body (outer housing)

75 Actuator

77 Second drain hole

78 Drain passage

78a Drain port

79 Drain path

90 Housing

CN Mating connector (charging plug)

X Left-right direction (horizontal direction)

Y Front-rear direction (fitting direction)

Z Up-down direction

What is claimed is:

1. A charging inlet comprising a housing to and from which a charging plug is attachable and detachable and which holds a connection terminal inside,
wherein the housing includes
a fitting recess to and from which the charging plug is attached and detached, and
a drain path extending from an inside of the fitting recess to an outside of the housing,
wherein the drain path includes a drain passage extending in a horizontal direction in a state where a device to which the charging inlet is attached is on a horizontal plane, and
wherein the drain passage has drain ports opened to the outside of the housing at both end portions in a length direction of the drain passage.

2. The charging inlet according to claim 1,
wherein the drain passage extends in a direction intersecting a fitting direction of the charging inlet and the charging plug.

3. The charging inlet according to claim 1, further comprising
an electric device attached to a lower portion of the housing,
wherein both drain ports of the drain passage are located outside the electric device in the length direction.

4. The charging inlet according to claim 1,
wherein the drain path includes a drain hole extending downward from the fitting recess, and
wherein the drain hole is connected to an intermediate portion of the drain passage in the length direction.

5. The charging inlet according to claim 1,
wherein the housing includes
an inner housing that faces an inner side of the fitting recess, and
an outer housing that covers an outer side of the inner housing, and
wherein the drain path is formed across the inner housing and the outer housing.
